(19) United States
(12) Patent Application Publication
(10) Pub. No.: US 2009/0299875 A1
(43) Pub. Date: Dec. 3, 2009

(54) SYSTEM TO FACILITATE ONLINE SHOPPING

(75) Inventors: Bin Zhu, Edina, MN (US); Rui Guo, Beijing (CN); Min Feng, Beijing (CN); Aimin Pan, Beijing (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/129,701

(22) Filed: May 30, 2008

(51) Int. Cl. G06Q 30/00

(52) U.S. Cl. 705/27

(57) ABSTRACT

A system for facilitating online shopping that includes one or more content providers of a first domain, one or more online merchants of a second domain, and a framework. Web pages may be aggregated from the content providers. Descriptions of products for sale may be aggregated from the online merchants. The products for sale may be matched with the web pages based on relevancy. A list of descriptions of products that are relevant to each web page may be provided. A shopping cart list may be maintained by the framework. The shopping cart list may facilitate payment for the products for sale selected from different web pages.

### BACKGROUND

In a long-tail phenomenon, a large group of small merchants can collectively compete in terms of sales volume with large-volume sellers. Some Internet advertising exploits the long tail phenomenon by providing venues for advertising on long-tail websites, whereby significant advertising revenues are generated by placing ads on a large number of websites. Websites that provide venues for advertising are compensated for each user that clicks on an ad viewed on the website. By clicking on an ad, the user is directed to a website for the advertiser, typically to another website for finding out more information about, or for buying, the advertised product.

### SUMMARY

In general, one or more implementations of various technologies described herein are directed towards providing a framework to turn any web page into an online store. Through a centralized framework, online merchants may register products for sale and content providers may register to offer their web pages as venues for the products for sale.

When a user requests a web page from a registered content provider, the web page may be displayed with a shopping window. A list of products related to the content of the web page may be displayed within the shopping window. The listed products may be products for sale by the registered online merchants which have been deemed as being relevant to the web page. Varying levels of description for the products may be displayed in response to a user action, such as a mouse-over or a pointer click.

Further, the user may select items for purchase from the list, whereby selected items may be placed into a user's virtual shopping cart. The shopping cart may be filled with products from various online merchants. The products may also be selected from various web pages and various web sites. A centralized payment system may also be provided to enable the user to pay for the selected items.

Advantageously, the user may perform this shopping without disruption to the browsing experience. Information about the products listed and the content of the shopping cart may all be presented to the user within the web pages that the user browses. A centralized payment system may also be provided to enable the user to check out, i.e., pay for the items placed in the shopping cart. In one implementation, the centralized payment system may enable the user to check out without having to leave the web pages.

Content providers may register with the framework to offer their web pages as venues for the products for sale. The content providers may be compensated according to products sold via a listing on the content providers' web pages.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a diagram of an online shopping system in accordance with implementations described herein.

FIG. 2 illustrates a schematic diagram of a computing system in accordance with implementations described herein.

FIG. 3A illustrates a web page in accordance with implementations described herein.

FIG. 3B illustrates a web page in accordance with implementations described herein.

FIG. 4 illustrates a flow diagram of a method in accordance with implementations described herein.

FIG. 5 is a flow diagram that illustrates a method in accordance with one or more implementations described herein.

### DETAILED DESCRIPTION

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that perform particular tasks or implement particular abstract data types. The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

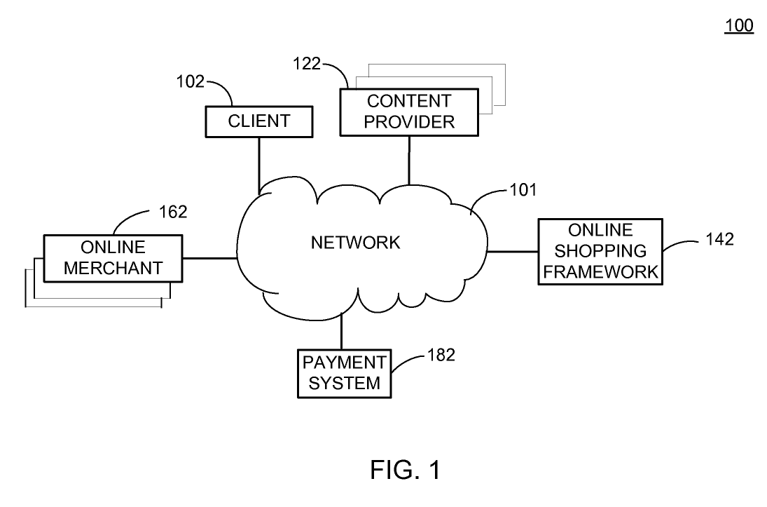

FIG. 1 illustrates a diagram of an online shopping system 100 in which the various technologies described herein may be incorporated and practiced. The online shopping system 100 may include a client 102, content providers 122, an online shopping framework 142, online merchants 162, and a payment system 182, remotely connected via a network 101.

The online shopping system 100 may be configured to integrate a web browsing experience with an online shopping experience. The online merchants 162 may register their products for sale with the online shopping framework 142. Similarly, the content providers 122 may register their web pages with the online shopping framework 142. For each registered web page, the online shopping framework 142 may determine a list of registered products that are relevant to the web page.

When the client 102 requests a web page that is registered with the framework 142, the content provider 122 may provide the client 102 with the requested web page content. Additionally, the framework 142 may provide the client 102 a list of registered products that are relevant to the content on the requested web page. Upon receipt of the web page from the content provider 122 and the list of products from the framework 142, the client 102 may display the web page, and the list of relevant products inside the web page. For the framework 142 to determine a list of relevant products based on the web page content, cross-domain communications may be needed to facilitate the exchange of information between the content provider 122 and the framework 142. In one implementation, the client 102 facilitates cross-domain communications that provide the framework 142 access to the web page content.

Additionally, the online shopping framework 142 may facilitate the user's selection of products from the displayed list and place selected products into a virtual shopping cart. As the user selects products from various web pages, the virtual shopping cart may contain products from numerous online merchants 162.

When the user wishes to check out, i.e., pay for the items placed in the shopping cart, the payment system 182 may facilitate payment to the numerous online merchants 162. The payment system 182 may be a centralized payment system for all online merchants 162. Alternatively, the online shopping system 100 may include multiple payment systems 182. In such a manner, each online merchant 162 may select a payment system 182 according to the online merchant's own needs.

In one implementation, the content providers 122 may be compensated for sales of products selected from the content providers' web pages. In such an implementation, the online shopping framework 142 may notify the content providers 122 about the particular sales of products selected from the content providers' web pages.

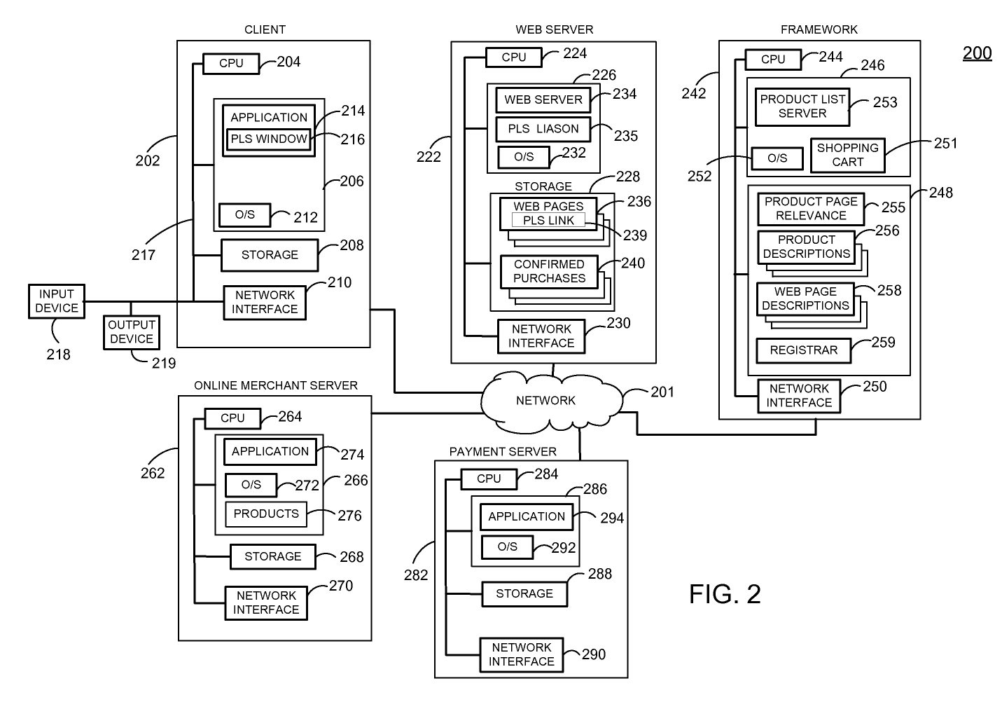

FIG. 2 illustrates a schematic diagram of a computing system 200 in which various technologies described herein may be incorporated and practiced. Although the computing system 200 may be a conventional desktop or a server computer, as described above, other computer system configurations may be used.

The computing system 200 may include a client 202, a web server 222, a framework server 242, an online merchant server 262, and a payment server 282 remotely connected via a network 201. The client 202, the web server 222, the framework server 242, the online merchant server 262, and the payment server 282 and their interaction will be described in more detail with reference to FIGS. 2-5 in the paragraphs below. Although the client 202, web server 222, framework server 242, online merchant server 262, and payment server 282 may be conventional desktops or server computers, as described above, other computer system configurations may be used.

The network 201 may be any network or collection of networks that link remote computers such as a local area network or a wide area network. In one implementation, the network 201 is the Internet.

The client computer 202 may include a central processing unit (CPU) 204, a memory 206 and a system bus 217 that couples various system components including the memory 206 to the CPU 204. It should be noted that the CPU 204 may include Virtualized systems (Virtual Machines, Processors), as well as CPU Cores and Hyper-threaded processors within a physical CPU. Although only one CPU is illustrated in FIG. 2, it should be understood that in some implementations the client computer 202 may include more than one CPU. The system bus 217 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The client computer 202 may be connected to the network 201 through a network interface 210. It will be appreciated that the network connection shown is exemplary and other means of establishing a communications link between the computers may be used.

The user may enter commands and information into the client computer 202 through an input device 218. Examples of input devices 218 include keyboards, pointing devices, microphones, joysticks, game pads, satellite dishes, scanners, or the like. These and other input devices may be connected to the CPU 204 through the system bus 217. The user may receive information from the client computer 202 via an output device 219. Examples of output devices 219 include displays, speakers, printers, and fax machines.

The client computer 202 may further include a storage 208, which may be connected to the bus 217. Examples of storage 208 include a hard disk drive for reading from and writing to a hard disk, a magnetic disk drive for reading from and writing to a removable magnetic disk, and an optical disk drive for reading from and writing to a removable optical disk, such as a CD ROM or other optical media. The storage 208 and associated computer-readable media may provide nonvolatile storage of computer-readable instructions, data structures, program modules and other data for the client computer 202.

It should be appreciated by those skilled in the art that the client computer 202 may also include other types of storage 208 and associated computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the client computer 202. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of any of the above may also be included within the scope of computer readable media.

A number of program modules may be stored in memory 206, including an operating system 212 and a client application 214. The operating system 212 may be any suitable operating system that may control the operation of a networked personal or server computer, such as Windows® Vista, Mac OS® X, Unix-variants (e.g., Linux® and BSD®), and the like.

The client application 214 may be software for displaying and interacting with text, images, videos, music and other information located on a web page 236 on the web server 222. In one implementation, the client application 214 is a web browser. The web browser may display, within the web page 236, a list of products for sale from one or more online merchants 162. The list of products may be presented alongside content on the web page 236 that has been deemed as relevant to the listed products. For example, where the web page 236 includes content about a popular musical artist, the product list may contain songs, or other media by the artist, for sale. Additionally, while browsing the web page 236, the user may select products from the list that the user would like to purchase.

In one implementation, the web browser may also include a product list server (PLS) window 216. The PLS window 216 may be configured to retrieve a list of products 276 from the framework server 242 that are relevant to the content of the web page 236. Additionally, the PLS window 216 may display a list of products 276 of a first domain within a web page 236 of a second domain. The PLS window 216 may also display a list of products selected for purchase within a shopping cart 251. The shopping cart 251 may include a list of products selected for purchase by the user while viewing one or more web pages 236.

Although the products listed for sale and the content of the web page may be related, the online merchants 162 selling the products listed may not be related to the content provider 122 of the web page 236. Typically, the content provider 122 and online merchants 162 operate within different domains on the web.

The online merchant servers 262 may be operated by the online merchants 162, and may be similarly constructed as the client computer 202. Each of the online merchant servers 262 may contain a CPU 264, memory 266, storage 268, and network interface 270. At the online merchant server 262, the memory 266 may include an operating system 272 and a merchant application 274. The merchant application 274 may be software that communicates with the framework server 242 to register products 276 for sale.

In one implementation, the products 276 may be digital products, such as songs, video, images, and the like. Advantageously, digital products may be downloaded directly to the client 202, without need for an intermediary shipping service. Further, some digital products, such as images and songs, may have a monetary value that increases the likelihood of impulse purchasing. As such, online merchants 162 may profit from selling the products 276 via implementations described herein.

For example, the user browsing a web page about an artist may be willing to buy a one dollar song by that artist, as opposed to a ten or fifteen dollar album. It should be noted, however, that implementations described herein are not limited to digital products of low monetary value. Rather, both digital and real-world, tangible products of any monetary value may be included.

The web servers 222 may be operated by the content providers 122 and may be similarly constructed as the client computer 202. Each of the web servers 222 may contain a CPU 224, memory 226, storage 228, and network interface 230. At the web server 222, a number of program modules may be stored in memory 226, including an operating system 232, a web server application 234, and a product list server (PLS) liaison 235.

The web server application 234 may receive hypertext transfer protocol (HTTP) request for a web page 236 from the client 202, retrieve the web page 236 from storage 228, and respond with the web page 236, containing a PLS link 239, described below. The web page 236 may be a hypertext markup language (HTML) document.

The PLS liaison 235 may add a PLS link 239 to the framework 242 to facilitate operation of the PLS window 216 on the client 202. The PLS link 239 may be stored within the web page 236. The PLS liaison 235 may also receive payment confirmation from the framework server 242 for products selected from the web pages 236 on the web server 222. Additionally, the PLS liaison 235 may maintain records of confirmed purchases 240 in the storage 228. The confirmed purchases 240 may include details about individual purchases, such as the web page 236 from which a sold product is selected, a user/buyer identifier, sale price, date of sale, and the like.

The web pages 236 may contain a PLS link 239. The PLS link 239 may be a reference to resources from the framework server 242 or software code embedded within the web page code that is configured to be executed by the application 214 to generate and operate the PLS window 216. The PLS link 239 may include a uniform resource locator (URL) that identifies the source of the content of the PLS window 216 on the framework server 242. In one implementation, the PLS link 239 may be a resource reference in an iframe. In another implementation, the PLS link 239 may be JavaScript, although other software code known or unknown may be used.

The framework server 242 may be similarly constructed as the client 202, and may also contain a CPU 244, memory 246, storage 248, and network interface 250. At the framework server 242, the storage 248 may include a registrar application 259, product descriptions 256, web page descriptions 258, and a product page relevance 255. The registrar application 259 may register web pages 236 by aggregating the web pages 236 for various content providers 122 into the web page descriptions 258. Similarly, the registrar application 259 may register the products 276 for various online merchants 162 by aggregating product descriptions into the product descriptions 256.

The registrar application 259 may further record a designated payee for each of the registered products 276. The designated payee may be the online merchant 162, or a third-party payee of the online merchant's choosing. The designated payee provided during registration may identify the payment system 182 through which payment arrangements between the user and the online merchants 162 are facilitated.

The memory 246 may include an operating system 252, a product list server (PLS) application 253, and the shopping cart 251. The PLS application 253 may match the product descriptions 256 with the web page descriptions 258 to produce a product page relevance 255. The product page relevance 255 may describe the relevance of each product description 256 to each web page description 258.

Additionally, the PLS application 253 may provide a list of descriptions of the products 276 that are relevant to each web page 236 in response to a request from the PLS window 216. The list of descriptions provided may be based on the product page relevance 255. The PLS application 253 may further aggregate the products selected for purchase by the user to the shopping cart 251.

In some cases, the content of the web pages 236 may be dynamic. In other words, the relevance of the web pages 236 to the product descriptions 256 may not be determined at the time of registration. As such, in one implementation, the PLS application 253 may conduct cross-domain communication with the web server 222 to determine the content on the web pages 236. In such an implementation, the PLS application 253 may then match the product descriptions 256 to the content of the web pages 236 and provide the list of descriptions based on relevance of the product descriptions 256 to the dynamic content.

The payment server 282 may be similarly constructed as the client computer 202, and may contain a CPU 284, memory 286, storage 288, and network interface 290. At the payment server 282, the memory 286 may contain an operating system 292, and a payment application 294. The payment application 294 may facilitate arrangements for payment terms between the user and online merchants 162 for the products 276 that the user places in the shopping cart 251. Additionally, the payment application 294 may send the framework server 242 a notification that the online merchant 162 and the user have agreed to payment terms for the product 276. In response, the PLS application 253 may send the web server 222 the payment notification.

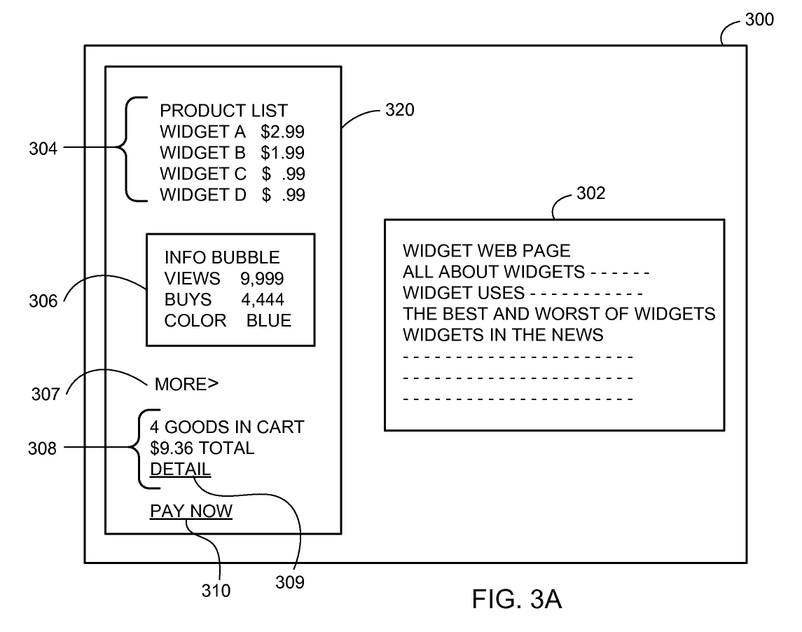

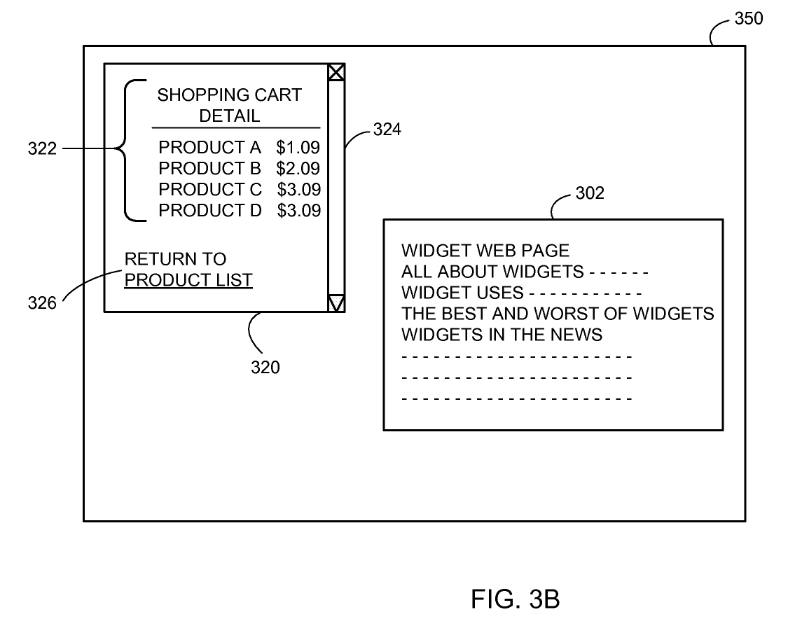

FIG. 3A illustrates a web page 300 in accordance with various implementations described herein. The web page 300 includes web page content 302 and a product list window 320. The web page content 302 may be any content on any web page 236. Both static content and dynamic content may be included in various implementations described herein. In the example shown, the web page content 302 relates to “WIDGETS.”

The product list window 320 may include a product list 304, a product overview 306, a shopping cart overview 308, and a payment link 310. The product list 304 may list products for sale that are related to the web page content 302. Additionally, the products listed may be for sale by the online merchants 162 of a domain that is distinct from the domain of the content provider 122 of the web page 300. As shown, the product list 304 includes various “WIDGETS,” and respective prices for each “WIDGET.” Implementations described herein may include other information to assist the user in the decision to buy, such as an icon reflecting a trademark or other images.

In a scenario where there are more products relevant to the web page content 302 that can be presented in the product list window 320, a “MORE” hyperlink 307 may be included in the product list window 320. The “MORE” hyperlink 307 may be configured to retrieve additional product lists 304 from the framework server 242. In such a scenario, the PLS window 216 may present the additional product lists 304 in the product list window 320.

The product overview 306 may appear for a particular product as a result of a user action. In one implementation, the product overview 306 appears in response to a mouse over action on a product in the product list 304. In this example, the product overview 306 describes “WIDGET D” from the product list 304.

The product overview 304 may provide basic information about a particular product that may be relevant to the user's purchasing decision. As shown, the product overview 304 may include, “VIEWS,” “BUYS,” and “COLOR.” The “VIEWS” may describe the number of times that the product is viewed by users. The view count may be relevant to the user's purchasing decision if the user is interested in products of great interest.

The “BUYS” may describe the number of purchases facilitated by the online shopping system 100. The “BUYS” may be relevant to the user's purchasing decision if the user is interested in popular products. “COLOR” is included in the product overview 306 as an example of a detail about a tangible product that may be relevant to the user's purchasing decision.

The user may select products for purchase from the product list 304 with a pointer action, such as a mouse click. In response to receiving the purchase selection, the PLS window 216 may update the shopping cart overview 308 to include the selected product. Additionally, the PLS window 216 may send an update message to the framework server 242. In response, the PLS application 253 may update the shopping cart 251 to include the selected product. Advantageously, the user may shop for products sold by an online merchant 162 of a domain that is distinct from the domain of the content provider 122 of the web page 300. Further, the user may shop online without having to disrupt the web browsing experience. Product purchase selections can take place within the web page 300 that the user is currently browsing.

The shopping cart overview 308 may describe the current contents of the user's shopping cart 251. Such basic information as the number of goods, i.e., products, and the total sale price of those products may be included, as shown in FIG. 3A. In one implementation, the user may click on a “DETAIL” hyperlink 309 to view a detailed description of the shopping cart 251. The detailed cart description is described with reference to FIG. 3B in the paragraphs below.

Below the shopping cart overview 308, the payment link 310 is shown. The payment link 310 may be a hyperlink that is configured to receive a payment request from the user in the form of a click. Additionally, the hyperlink maybe configured to send the payment request to the framework server 242. In response, the PLS application 253 may direct the client 102 to the payment server 282 in order to arrange payment terms for the products 276 in the shopping cart 251.

It should be noted that the product list 304, product overview 306, and the shopping cart overview 308 described here are merely provided as examples and are not intended to limit implementations described herein. Those skilled in the art recognize that many options exist for information presented in the product list 304, product overview 306, and the shopping cart overview 308. The information presented may be constrained only by the amount of information that can be presented within the product list window 320. The information provided in the product list 304, product overview 306, and shopping cart overview 308 may vary in implementations described herein. More specifically, the information presented in the product list 304 and product overview 306 may even vary from product to product within the same product list 304.

All web pages registered by a content provider 122 may include the product list window 320. As the user browses different registered web pages or different registered web sites, the user may place numerous products 276 in the shopping cart 251. As such, the shopping cart 251 may include products for sale by different online merchants 162. However, when browsing a web site that is not registered with the online shopping framework 142, the product list window 320 may not be displayed. To facilitate continuity, in one implementation, if the user moves from a registered web site to a non-registered web site, the user may be prompted to check-out, i.e., pay for the items in the shopping cart 251 before proceeding to the non-registered web page.

In some cases, the user may require more than the basic information provided in the product overview 304 to make the purchasing decision. Accordingly, in one implementation, the user may request a detailed description of a product. The detailed description may be presented within the product list window 320.

FIG. 3B illustrates a screenshot 350 of the web page 300 with a detailed description of the shopping cart 251 in accordance with implementations described herein. The screen shot 350 includes the web content 302, and the product list window 320. However, the product list window 320 in the screen shot 350 includes a detailed cart description 322, and a scroll bar 324.

The detailed cart description 322 may be displayed to the user in response to a pointer action, such as a right or left mouse-click on the shopping cart overview 308. The detailed cart description 322 may list the individual products, along with pricing information, currently in the shopping cart 251. As stated previously, the products listed in the detailed cart description 322 may be from multiple online merchants 162 operating in multiple domains.

The product list window 320 may also include the scroll bar 324 to facilitate displaying long lists of products in the shopping cart 251. It should be noted that the scroll bar 324 may also be included alongside the product list 304 to facilitate longer product lists than the product list 304 shown in FIG. 3A.

The product list window 320 may also include a hyperlink 326 configured to return to the product list window 320 illustrated in FIG. 3A.

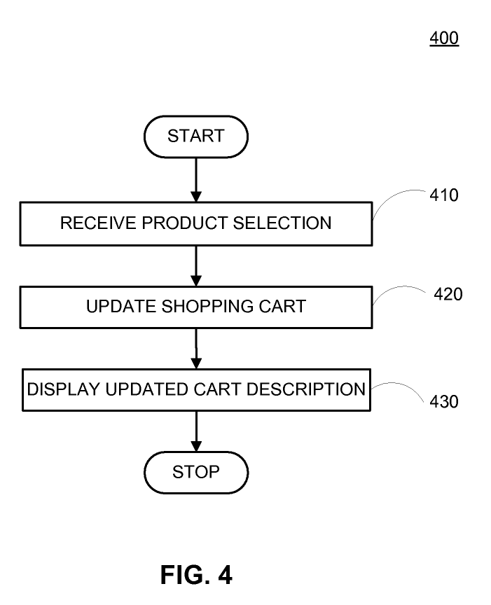

FIG. 4 illustrates a flow diagram of a method 400 in accordance with implementations described herein. In one implementation, the method 400 may be performed by the PLS window 216. It should be understood that while the flow diagram indicates a particular order of execution of the operations, in some implementations, certain portions of the operations might be executed in a different order.

At step 410, the PLS window 216 may receive a product selection from the user. The product selection may indicate that the user is selecting a particular product 276 for purchase. The product 276 may be of a domain distinct from the domain of the web page 236 within which the product is presented to the user.

At step 420, the PLS window 216 may update the shopping cart 251 by adding the selected product 276 to the shopping cart 251. At step 430, the PLS window 216 may display an updated cart description to the user in the shopping cart overview 308.

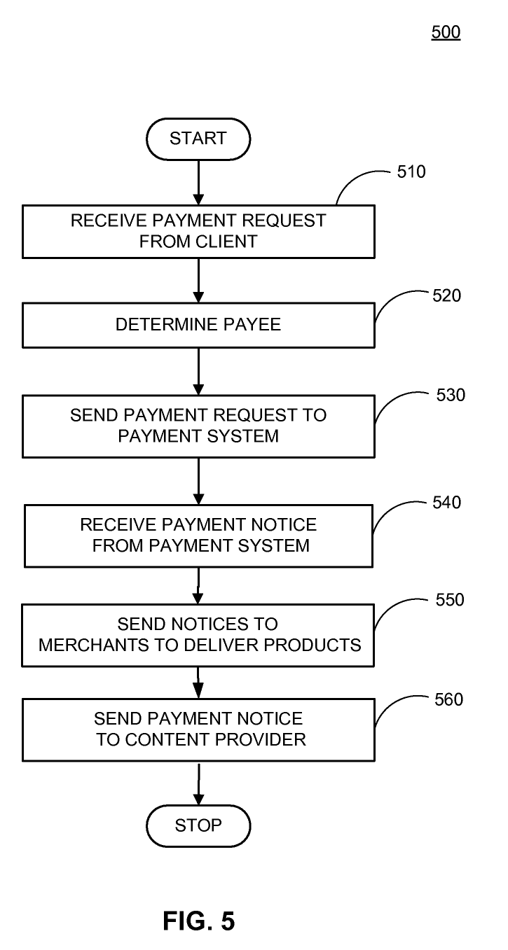

FIG. 5 is a flow diagram that illustrates a method 500 in accordance with one or more implementations described herein. In one implementation, the method 500 may be performed by the PLS application 253. It should be understood that while the flow diagram indicates a particular order of execution of the operations, in some implementations, certain portions of the operations might be executed in a different order.

At step 510, the PLS application 253 may receive a payment request from the client 102. The payment request may include the list of products 276 selected for purchase in the shopping cart 251, a user identifier, and identifiers for the web pages 236 from which the products 276 are selected for purchase.

At step 520, the PLS application 253 may determine the designated payee for the products 276 selected for purchase. In one implementation, the designated payee may be a centralized payment server that facilitates payment for all the selected products from various online merchants 162. In another implementation, the designated payee may be specified by the online merchants 162 of the selected products described within the product descriptions 256.

At step 530, the PLS application 253 may send a payment request to the payment system 182 for the products selected for purchase and payees. At step 540, the PLS application 253 may receive notifications that the online merchants 162 have agreed to payment terms for the products selected for purchase.

At step 550, the PLS application 253 may send notifications to the online merchants 162 that the user agreed to payment terms for the selected products. In response, the online merchants 162 may ship the selected products to the user. If a selected product is a digital product, the product can be delivered immediately.

At step 560, the PLS application 253 may send payment notifications to the content providers 222 from whose web pages 236 the products are selected for purchase. In response, the PLS liaison 234 may record the payment notification within the confirmed purchases 240. The content providers 122 may use the confirmed purchases 240 to account for compensation for all purchases made via selections of products 276 from the content providers' web pages 236.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system for facilitating online shopping, comprising:
one or more content providers of a first domain;
one or more online merchants of a second domain; and
a framework configured to:
aggregate web pages from the content providers;
aggregate descriptions of products for sale from the online merchants;
match the products for sale with the web pages based on relevancy; and
provide a list of descriptions of products that are relevant to each web page; and
maintain a shopping cart list within one of the web pages, the shopping cart list facilitating payment of the products for sale.

2. The system of claim 1, wherein the framework is further configured to:
conduct cross-domain communications to determine content of one of the web pages, and
determine the list of descriptions of products that are relevant to the one of the web pages based on the aggregated descriptions and the content.

3. The system of claim 1, wherein the framework is further configured to notify the content providers that the online merchants have agreed to payment terms for the products for sale that have been selected for purchase.

4. The system of claim 1, wherein the framework is further configured to:
receive one or more selections on one or more of the descriptions, each selection being a request to purchase the products that correspond to the descriptions; and
aggregate the selections to the shopping cart.

5. The system of claim 4, further comprising:
one or more online merchants of a third domain.

6. The system of claim 4, further comprising:
one or more content providers of a fourth domain.

7. The system of claim 6, further comprising:
one or more online merchants of a third domain.

8. A method for facilitating non-disruptive online shopping, comprising:
providing a list of descriptions for one or more products of a first domain that are relevant to a web page of a second domain;
receiving one or more selections on one or more of the descriptions, each selection being a request to purchase a product that corresponds to one of the descriptions; and
aggregating the selections to a single shopping cart.

9. The method of claim 8, wherein the list further comprises descriptions for one or more products of a third domain.

10. The method of claim 8, wherein the one or more products of the first domain are further relevant to a web page of a fourth domain.

11. The method of claim 10, wherein the list further comprises descriptions for one or more products of a third domain.

12. The method of claim 8, further comprising:
receiving a payment request for the products in the single shopping cart;
determining one or more payees that arrange payment terms for the products;
sending the payment request to the one or more payees;
receiving a payment confirmation that the online merchant has agreed to payment terms for the products, wherein the payment confirmation is received from the payee; and
sending the payment confirmation to a content provider that provides the web page of the second domain.

13. The method of claim 8, further comprising providing information regarding a product when a mouse is hovered over a description for the product.

14. The method of claim 8, further comprising displaying the list of descriptions for the products of the first domain on the web page of the second domain.

15. A user interface for facilitating online shopping, comprising:
displaying within a web page of a first domain, a list of products for sale from a online merchant of a second domain;
receiving a purchase selection for one of the products for sale;
sending the purchase selection to a framework for online shopping; and
displaying a shopping cart describing the one of the products for sale that has been selected for purchase, wherein the shopping cart is displayed within the web page of the first domain.

16. The user interface of claim 15, further comprising:
displaying within a web page of a third domain, the list of products for sale from the online merchant of the second domain.

17. The user interface of claim 15, further comprising:
displaying within the web page of the first domain, a list of products for sale from a fourth online merchant of a fourth domain.

18. The user interface of claim 15, further comprising:
displaying within a web page of a third domain, a list of products for sale from a fourth online merchant of a fourth domain.

19. The user interface of claim 18, further comprising:
receiving a payment request for the one of the products for sale; and
sending the payment request to a framework for online shopping.

20. The user interface of claim 15, further comprising:
receiving a payment request for the one of the products for sale; and
sending the payment request to a framework for online shopping.
